(19) United States
(12) Patent Application Publication
(10) Pub. No.: US 2004/0007112 A1
(43) Pub. Date: Jan. 15, 2004

(54) Paper cutter with burr-edged blade

(76) Inventors: Gerald Paul Fregeolle, (US); Michael Lee Parrish, Huntersville, NC (US)

Correspondence Address: Gregory S. Bernabeo, Esq., Synnestvedt & Lechner LLP, 2600 Aramark Tower, 1101 Market Street, Philadelphia, PA, 19107-2950, US

(21) Appl. No.: 10/403,237

(22) Filed: Mar. 28, 2003

Related U.S. Application Data
(60) Provisional application No. 60/395,007, filed on Jul. 11, 2002.

(51) Int. Cl. B26D 5/08

(52) U.S. Cl. 83/607

(57) ABSTRACT

A paper cutter having a base, a first blade fixedly mounted to the base and a cutting arm pivotally mounted to the base for pivotal motion in a substantially vertical plane and supporting a second blade. The first blade has a cutting edge having a longitudinally extending burr, and is mounted to the base with the burr adjacent the base's side and extending away from the base to cooperate with the second blade for cutting. The burr-edged first blade may be positioned on the base at an angle thereto to better position the burr for acting as the cutting edge. The burr may be formed by stamping the first blade from metal sheet stock, thereby eliminating the need for traditional grinding or other processing steps, and related costs.

### CROSS-REFERENCE TO RELATED APPLICATION

This application claims the benefit of U.S. Provisional Patent Application No. 60/395,007, filed Jul. 11, 2002, the entire disclosure of which is hereby incorporated by reference.

### FIELD OF THE INVENTION

The present invention relates generally to a cutter for sheet material, and particularly to a paper cutter having a cutting blade.

### DISCUSSION OF RELATED ART

Cutters or trimmers for sheet material, typically referred to as paper cutters, are in widespread use in educational, institutional, commercial, corporate and other environments for cutting paper, cardboard or sheets of other materials. An exemplary paper cutter includes a flat cutting board base having a sharp cutting edge adjacent its side, and a cutting arm pivotally mounted to the base adjacent the cutting edge. The cutting arm supports a sharp blade that cooperates with the cutting edge on the base to cut any sheets therebetween when the cutting arm is pivoted to draw its blade down along the cutting edge.

Exemplary paper cutters are disclosed in U.S. Pat. No. 215,205 to Bradley, U.S. Pat. No. 1,123,191 to Hastings, U.S. Pat. No. 2,460,205 to Webster, U.S. Pat. No. 2,591,472 to Segal, U.S. Pat. No. 3,811,355 to Cole, and U.S. Pat. No. 5,320,011 to Lee. These paper cutters are exemplary of many well known paper cutters in that the cutting edge on the base is provided by mounting a flat plate-like blade substantially horizontally on the top surface of the base. U.S. Pat. No. 19,046 to Ruggles, U.S. Pat. No. 541,503 to Razoux, and U.S. Pat. No. 5,044,243 to Aizawa show paper cutters having similar blades mounted substantially vertically on the side of the base. Such blades are relatively expensive as they require substantial processing steps, which typically include grinding or otherwise providing a suitable surface on the blade to provide a suitable cutting edge for cooperating with the cutting arm's blade to cut sheets. The grinding or other processing steps are particularly expensive, adding to manufacturing costs for a paper cutter having such a blade.

What is needed is a blade arrangement that reduces or eliminates such manufacturing steps and/or costs.

### SUMMARY

The present invention provides a paper cutter having a base, a first blade fixedly mounted to the base, and a blade-supporting cutting arm pivotally mounted to the base for pivotal motion in a substantially vertical plane. The first blade has a cutting edge having a longitudinally extending burr. The blade is mounted to the base with the burr adjacent the base's side and extending away from the base to cooperate with the cutting arm's blade for cutting sheet material positioned on the base to overhang the cutting edge. The burr may be formed by stamping the first blade from metal sheet stock, thereby eliminating the need for traditional grinding or other processing steps, and related costs.

The burr-edged first blade may be positioned on the base at an angle thereto to better position the burr for acting as the cutting edge. The burr-edged blade may be positioned either substantially vertically on the side of the base, or substantially horizontally in substantially a plane of the top surface of the base.

The second blade may also be formed to include a similar burr, thereby eliminating processing steps and related costs for the second blade.

### DESCRIPTION OF THE DRAWINGS

FIG. 1 is a perspective view of a paper cutter in accordance with an exemplary embodiment of the present invention;

FIG. 2 is an alternative perspective view of the paper cutter of FIG. 1;

FIG. 3 is a top view of the paper cutter of FIG. 1;

FIG. 4 is a partial cross-sectional view of the paper cutter of FIG. 1, taken along line 4-4 of FIG. 3;

FIG. 5 is an enlarged detail view of the area 5 of FIG. 4;

FIGS. 6 and 7 are side and top plan views, respectively, of an apparatus for making the blade of the paper cutter of FIGS. 1-5; and

FIG. 8 is an enlarged detail view of the area 8 of FIG. 4, in accordance with a certain embodiment of the present invention.

### DETAILED DESCRIPTION

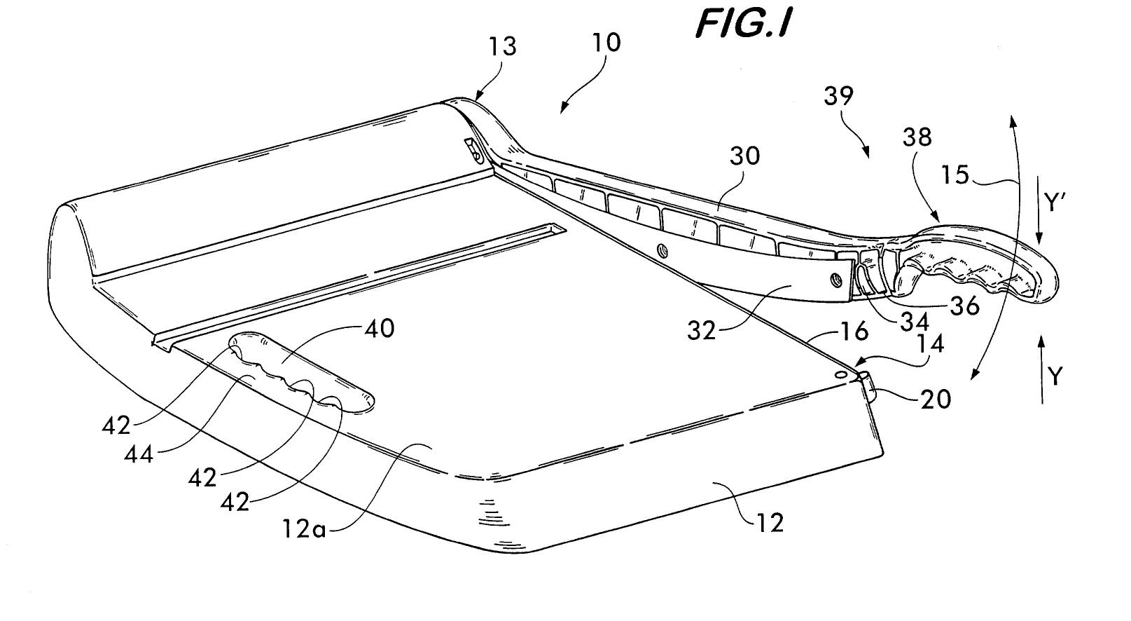

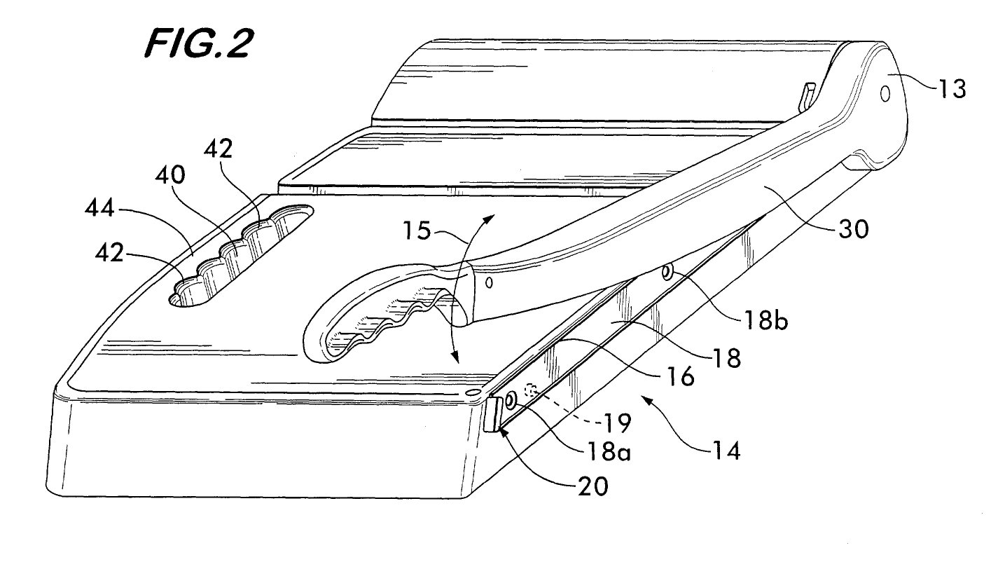

FIGS. 1-5 show a paper cutter 10 in accordance with an exemplary embodiment of the present invention. As best shown in FIGS. 1 and 2, the paper cutter 10 is of a type generally well-known in the art in that it includes a base 12 having a top surface 12a for supporting sheets to be cut, and a cutting arm 30 pivotally mounted at arm end 13 to the base 12 for pivotal motion in a substantially vertical plane as represented by reference number 15. The base 12 and cutting arm 30 may be formed primarily of a synthetic resin to provide a relatively lightweight and low cost paper cutter. The cutting arm 30 has a blade 32 supported thereon, such as a steel blade, for cutting sheet material. For example, the blade 32 may be fastened to the cutting arm 30 by screws or by injection molding the cutting arm to interlock with the blade 32. The base 12 provides a cutting edge 16 for cooperating with the blade 32 of the cutting arm 30 to cut sheets.

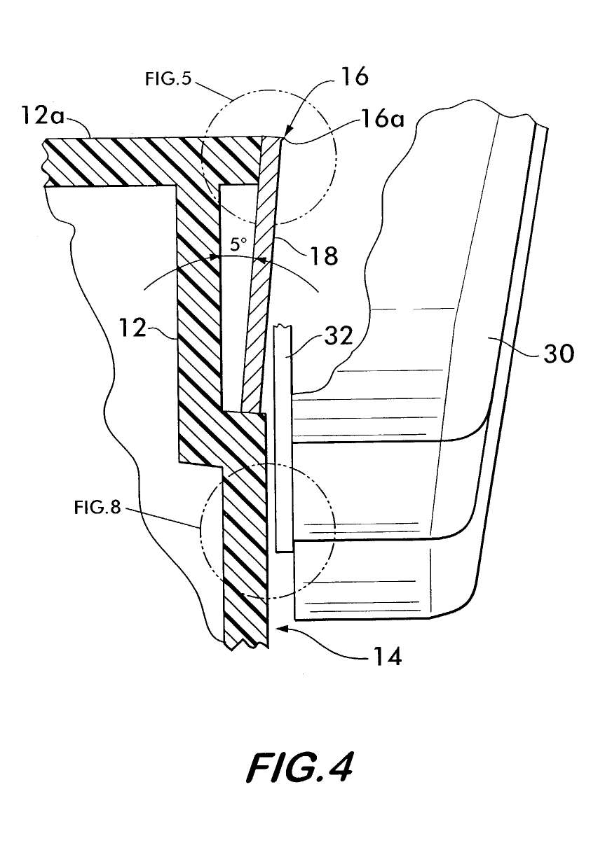

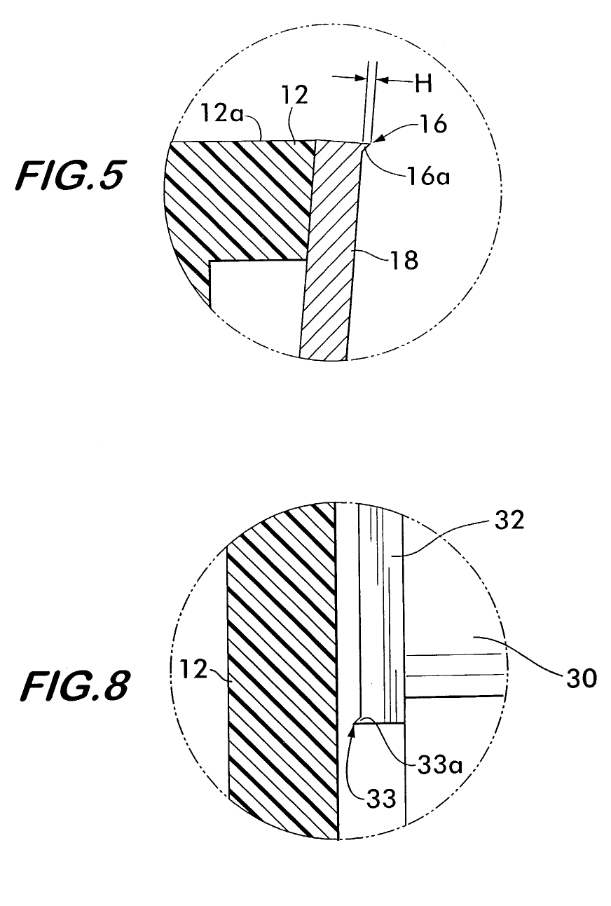

As shown in FIGS. 1-5, the base 12 supports a blade 18 which is fastened, e.g. by screws or by injection molding of the base 12 around the blade 18, in a substantially vertical position on the side 14 of the base 12 to expose a cutting edge 16 for cooperating with the blade 32 of the cutting arm 30. As best shown in FIGS. 4 and 5, the blade 18 is formed in a manner to create a burr 16a extending longitudinally along the blade's edge 16. The burr 16a includes a jagged, rough and/or sharp edge resulting from the process of forming the blade. For example, a burr 16a having a height H, as shown in FIG. 5, of approximately 0.005 inches has been found suitable for use as the cutting edge. Grinding or other subsequent processing steps typically required to provide a suitable cutting edge on the blade is thereby eliminated. The elimination of such processing steps provides corresponding savings in manufacturing costs.

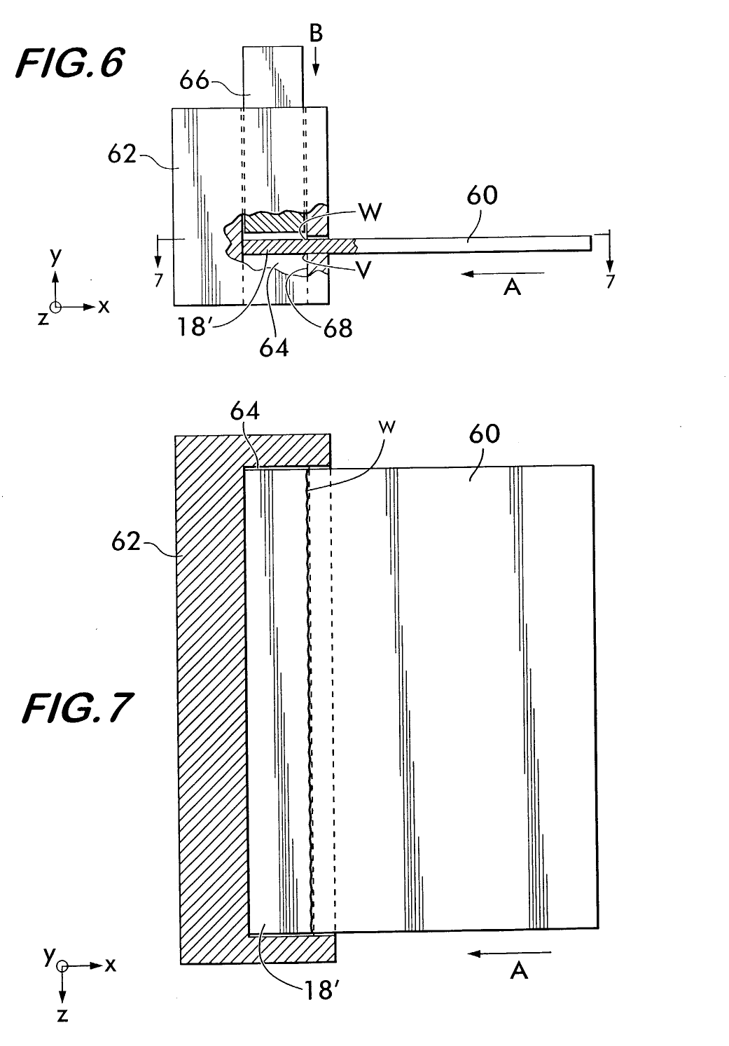

The blade 18 may be formed to create the burr 16a by stamping the blade from metal sheet stock. An exemplary apparatus for stamping the blade from metal sheet stock is illustrated in FIGS. 6 (side view) and 7 (top view). The apparatus is shown for illustrative purposes as a simplified form of punch and die, and it will be appreciated by those skilled in the art that conventional apparatus may be used to perform the stamping process. Referring now to FIGS. 6 and 7, metal sheet stock 60 is fed in direction A into a stamping die 62 until it overlaps an opening 64 of the die 62 that will define the shape of the blade 18. As best shown in FIG. 6, a punch 66 is then advanced toward the opening 64 in direction B to shear off a portion 18′ (shown cross-hatched in FIGS. 6 and 7) of the metal sheet stock 60 that is positioned over the opening 64. The sheared portion 18′ is used as the blade 18.

The motion of the punch 66 relative to the stationary interior wall or edge 68 of the die 62 causes the metal sheet stock to shear or tear. In the example of FIGS. 6 and 7, this shearing or tearing of the metal sheet stock 60 creates the jagged, rough and/or sharp edge on the sheared portion 18′ along the edge area W on the top side (as shown in FIG. 6) of the sheet stock 60. This edge extends away from the body of the blade 18 (generally upwardly in FIG. 6) to form burr 16a (FIG. 5). This shearing or tearing also creates a similar edge on the remaining portion of the metal sheet stock 60 along the edge area V on the bottom side (as shown in FIG. 6) of the sheet stock, the edge extending away from the metal sheet stock 60 (downwardly in FIG. 6) to form another burr. Accordingly, each blade 18 formed in this way has a burr along each longitudinal edge, but on opposite sides of the blade (one burr extending downwardly on the bottom side on a first longitudinal edge and another extending upwardly on the top side on an opposite longitudinal edge, in the orientation shown in FIG. 6). When the burr is formed on the blade portion 18′ or sheet stock 60, a generally complementary cupped portion is formed on the sheet stock 60 or blade portion 18′, respectively. After formation of a first blade 18, the metal sheet stock 60 is advanced in direction Z by one blade width, and the shearing process is repeated to form a next blade.

The blade 18 is oriented on the base 12 to position the blade 18 with the burr 16a positioned for use as the cutting edge 16, as shown in FIG. 5. Preferably, the blade 18 includes openings 18a, 18b (see FIG. 2) or other alignment fiducials 19 (e.g. a complementary opening and boss on the blade 18 and base 12) that are eccentrically located to ensure that the blade 18 can be assembled to the base 12 in the proper orientation only.

In the vertical orientation of FIGS. 1-5, the blade 18 is mounted on the base 12 at an acute angle (e.g. approximately 1 to 10 degrees, and preferably 5 degrees) to a vertical (plumb) reference plane perpendicular to the horizontal top surface 12a of the base 12. This angled orientation better exposes the burr/cutting edge, as best shown in FIGS. 4 and 5, for co-acting with the blade of the cutting arm 30. This orientation also reduces friction and wear of the blades 18, 32 as only a limited portion of the blade 18 (namely the burr 16a) is in contact with the cutting arm's blade 32 at any point in time.

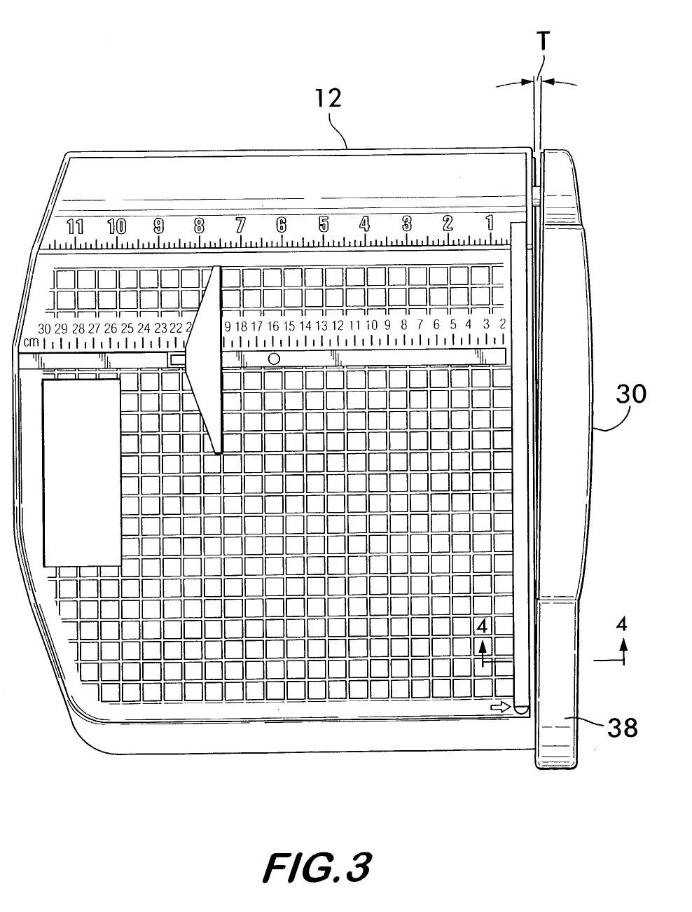

Preferably, as shown in FIG. 3, the cutting arm 30 is mounted to the base 12 such that the blade 32 of the cutting arm 30 is oriented at an angle T to the blade 18 of the base. For example, an angle T of approximately 1-5 degrees, and preferably 1.3 degrees, has been found suitable for this purpose. As a result of this longitudinal angling of the blades, as the cutting arm 30 is pivoted downwardly, a point of contact between the blades 32, 18 moves along the length of the blade 32 toward handle 38, such that only a limited portion of the blades 32, 18 are in contact at any point of time. This further limits wear on the blades and allows for spring biasing of the pivotable blade 32 toward the fixed blade 18 to provide a moving point of contact between the blades, i.e. a scissor-like cutting action. A similar scissor-like cutting action and longitudinally angled blade orientation is disclosed in U.S. Pat. No. 2,089,274 to Laukhuff, the entire disclosure of which is hereby incorporated by reference.

The use of such a burr 16a is particularly advantageous when the blade is oriented substantially vertically adjacent a side 14 of the base 12, as shown in FIGS. 1-5. However, a similar advantage may be achieved when the blade is mounted substantially horizontally on the top surface 12a of the base 12 (i.e. substantially in the place of the top surface 12a), not shown, as generally known in the art. This may require different positioning of the blade on the base, i.e. positioning at an acute angle to horizontal, in order to properly position the burr for cooperating with the blade 32 of the cutting arm.

In one embodiment, the second blade 32 is ground and/or processed in a conventional manner to provide an appropriate cutting edge, as known in the art. In another embodiment, the second blade 32 is formed to a burr similar to that of the first blade 18. In such an embodiment, the blade 32 is formed in a manner to create a burr 33a extending longitudinally along the blade's edge 33, as shown in FIG. 8. The second blade 32 may be formed to create the burr 33a by stamping the blade from metal sheet stock, as described above with reference to FIGS. 6 and 7. The burr 33a includes a jagged, rough and/or sharp edge resulting from the process of forming the blade. For example, a burr 33a having a height of approximately 0.005 inches has been found suitable for use as the cutting edge. Grinding or other subsequent processing steps typically required to provide a suitable cutting edge on the blade is thereby eliminated. The elimination of such processing steps provides corresponding savings in manufacturing costs.

The second blade 32 is mounted to the cutting arm 30 with the burr 33a adjacent the cutting arm's side and extending away from the cutting arm to cooperate with base's blade 18 for cutting sheet material positioned on the base to overhang the cutting edge. In other words, the second blade 32 is positioned with the burr 33a extending toward the first blade 18 when the cutting arm 30 is positioned adjacent the base 12, as shown in FIG. 8.

Optionally, the paper cutter 10 includes an integral handle 44 for carrying the paper cutter 10. The integral handle 44 is formed as an integral part of the base 12. More specifically, the base defines an opening 40 internal to a perimeter of the base 12, such that the opening 40 extends through the base 12 to allow an individual's fingers to pass therethrough, as shown in FIG. 1. In a preferred embodiment, the base 12 is contoured such that the opening 40 defines a plurality of arcuate finger holds 42 for interfitting with the individual's fingers, as shown in FIG. 1. For example, base 12 may be injection molded to define the opening 40, finger holds 42 and handle 44.

Optionally, a paper cutter according to the present invention may include a structural safety latch, as disclosed in U.S. Pat. application Ser. No. ______ (Attorney Docket No. P25,629 USA), filed concurrently herewith, now U.S. Pat. No. ______, the entire disclosure of which is hereby incorporated herein by reference. Additionally, a paper cutter according to the present invention may include a modified pivot pin arrangement to further facilitate assembly, as disclosed in U.S. patent application Ser. No. ______ (Attorney Docket No. P25,630 USA), filed concurrently herewith, now U.S. Pat. No. ______, the entire disclosure of which is hereby incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A paper cutter comprising:
a base for supporting material to be cut, said base having a side;
a first blade fixedly mounted to said base, said first blade having a cutting edge comprising a burr extending longitudinally along said cutting edge, said burr of said cutting edge being adjacent said side and extending away from said base; and
a cutting arm having a second blade, said cutting arm being pivotally mounted to said base to allow said second blade to move relative to and cooperate with said first blade and cut sheet material positioned on said base and overhanging said cutting edge.

2. The paper cutter of claim 1, wherein said burr is formed by stamping said first blade from metal sheet stock.

3. The paper cutter of claim 2, wherein said burr is formed by:
positioning metal sheet stock over an opening of a stamping die; and
advancing a punch toward the opening to shear off a portion of the metal sheet stock, said portion comprising said first blade.

4. The paper cutter of claim 1, wherein said burr is formed by shearing said first blade from metal sheet stock.

5. The paper cutter of claim 1, wherein said first blade comprises an alignment fiducial for ensuring that said first blade can be mounted to said base only in a predetermined position, with said burr adjacent said side and extending away from said base.

6. The paper cutter of claim 5, wherein said alignment fiducial comprises an opening defined in said first blade.

7. The paper cutter of claim 1, wherein said first blade is mounted to said side of said base in a substantially vertical orientation.

8. The paper cutter of claim 7, wherein said first blade is mounted at an acute angle relative to a reference plane perpendicular to a top surface of said base.

9. The paper cutter of claim 8, wherein said acute angle is approximately five degrees.

10. The paper cutter of claim 1, wherein said cutting arm is mounted to said base to define an acute angle between said first blade of said cutting arm and said second blade of said base to provide a moving point of contact between said first and second blades as said second blade is pivoted relative to said first blade.

11. The paper cutter of claim 1, wherein said base defines an opening internal to a perimeter thereof, said opening extending through said base to allow an individual's fingers to pass therethrough.

12. The paper cutter of claim 11, wherein said opening defines a plurality of arcuate finger holds for interfitting with the individual's fingers.

13. A paper cutter comprising:
a base having a substantially planar top surface for supporting material to be cut, said base having a side;
a first blade having a cutting edge comprising a burr extending longitudinally along said cutting edge, said first blade being fixedly mounted to said side of said base at an acute angle relative to a reference plane perpendicular to said top surface of said base, said burr being adjacent said side and extending away from said base; and
a cutting arm having a second blade, said cutting arm being pivotally mounted to said base to allow said second blade to move relative to and cooperate with said first blade to cut sheet material positioned on said base and overhanging said cutting edge.

14. The paper cutter of claim 13, wherein said acute angle is approximately five degrees.

15. The paper cutter of claim 13, wherein said burr is formed by stamping said first blade from metal sheet stock.

16. The paper cutter of claim 15, wherein said burr is formed by:
positioning metal sheet stock over an opening of a stamping die; and
advancing a punch toward the opening to shear off a portion of the metal sheet stock, said portion comprising said first blade.

17. The paper cutter of claim 13, wherein said base defines an opening internal to a perimeter thereof, said opening extending through said base to allow an individual's fingers to pass therethrough.

18. The paper cutter of claim 17, wherein said opening defines a plurality of arcuate finger holds for interfitting with the individual's fingers.

19. A paper cutter comprising:
a base having a substantially planar top surface for supporting material to be cut;
a substantially flat first blade stamped from metal sheet stock to form a burr extending longitudinally along its edge, said first blade being fixedly mounted to said base, said burr being adjacent said side and extending away from said base; and
a cutting arm having a second blade, said cutting arm being pivotally mounted to said base to allow said second blade to move relative to and cooperate with said first blade to cut sheet material positioned on said base and overhanging said cutting edge.

20. The paper cutter of claim 19, wherein said first blade is mounted to said side of said base at an acute angle relative to a reference plane perpendicular to said top surface of said base.

21. The paper cutter of claim 19, wherein said base defines an opening internal to a perimeter thereof, said opening extending through said base to allow an individual's fingers to pass therethrough.

22. The paper cutter of claim 21, wherein said opening defines a plurality of arcuate finger holds for interfitting with the individual's fingers.

23. A paper cutter comprising:
a base having a top surface for supporting material to be cut;
a first blade fixedly mounted to said base, said first blade having a longitudinally extending first cutting edge; and
a cutting arm having a second blade, said second blade having a second cutting edge, said cutting arm being pivotally mounted to said base to allow said first and second cutting edges of said first and second blades to cooperate to cut sheet material positioned on said base between said cutting edges;
one of said first and second blades comprising a burr extending longitudinally along an edge thereof, said one of said first and second blades being positioned with said burr extending toward the other of said first and second blades when said cutting arm is positioned adjacent said base.

24. The paper cutter of claim 23, wherein said burr is formed by stamping said blade from metal sheet stock.
